(19) United States
(12) Patent Application Publication
(10) Pub. No.: US 2005/0043835 A1
(43) Pub. Date: Feb. 24, 2005

(54) Method for design and production of custom-fit prosthesis

(75) Inventor: Andrew M. Christensen, Littleton, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Medical Modeling LLC, Golden, CO (US)

(21) Appl. No.: 10/676,661

(22) Filed: Sep. 30, 2003

Related U.S. Application Data
(60) Provisional application No. 60/414,585, filed on Sep. 30, 2002.
(60) Provisional application No. 60/437,489, filed on Dec. 31, 2002.

(51) Int. Cl. G06F 19/00

(52) U.S. Cl. 700/98; 264/219

(57) ABSTRACT

Systems and methods are provided for designing and producing custom-fit prosthesis. According to one embodiment, a mold is produced from which a custom-fit implant may be directly manufactured. Medical image data representing surrounding portions of a patient's anatomy to be repaired by surgical implantation of the custom-fit implant are received. Then, three-dimensional surface reconstruction is performed based on the medical image data. Next, the custom-fit implant is designed based on the three-dimensional surface reconstruction and a two-part mold is created with a void in the shape of the custom-fit implant by subtracting a representation of the custom-fit implant from a representation of a mold. Finally, the two-part mold is output from which the custom-fit implant may be directly manufactured.

This application claims the benefit of U.S. Provisional Application No. 60/414,585, filed Sep. 30, 2002, entitled “Method for Design and Production of a Custom-Fit Cranioplasty Prosthesis” and U.S. Provisional Application No. 60/437,489, filed Dec. 31, 2002, entitled “Method for Design and Production of a Custom-Fit Cranioplasty Prosthesis” both of which are hereby incorporated by reference in their entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention relate generally to design and production of implants. More particularly, embodiments of the present invention relate to techniques for computer-designed, preformed implants via (i) production of precise molds for direct manufacture of the desired implant, (ii) production of “a mold of a mold” from which a new mold may be formed and used to manufacture the desired implant, (iii) direct production of the desired implant; (iv) delivery of data files representing any of the foregoing.

2. Description of the Related Art

The term cranioplasty refers to the surgical correction of a skull defect. These large defects of the human skull are created or caused by injury, surgical intervention for tumor removal, congenital abnormality or disease. Many times this repair and recontouring will involve either autogenous (body tissue) or alloplastic (man-made) materials, but in many cases of large defects there is not enough autogenous material to use for repair. Surgeons in the fields of neurosurgery, oral surgery and plastic surgery repair and recontour these defects using alloplastic materials such as polyehtylene, polymethylmethacrylate, tantalum, cobalt-chrome, hydroxyapatite, titanium, and methylmethacrylate (bead or solid form). Currently, most surgeons fixing these defects do so by forming the material at the time of surgery with the patient's anatomy exposed. the current method exposes the patient to longer surgery and often leaves a less than desirable appearance, especially with large defects. Issues of symmetry between the right and left sides of the head and reconstruction of a bilateral defect are difficult to consider when forming the implant during surgery.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 conceptually illustrates a high-level, simplified view of a network environment in which one embodiment of the present invention may be employed.

FIG. 2 is a block diagram that conceptually illustrates a custom prosthesis development system according to a first embodiment of the present invention in which the final mold from which the implant may be directly manufactured or data files representative thereof may be delivered to an implant manufacturer.

FIG. 3 is a block diagram that conceptually illustrates a custom prosthesis development system according to a second embodiment of the present invention in which “a mold of a mold” from which the final mold may be manufactured or data files representative thereof may be delivered to an implant manufacturer.

FIG. 4 is a block diagram that conceptually illustrates a custom prosthesis development system according to a third embodiment of the present invention in which the implant or data files representative thereof may be delivered.

FIG. 5 is an example of a computer system upon which one embodiment of the present invention may be implemented.

FIG. 6 is a flow diagram illustrating the design and production of a final mold from which a custom-fit prosthesis may be directly manufactured according to one embodiment of the present invention.

FIG. 7 is a flow diagram illustrating the design and production of “a mold of a mold” from which a final mold for the desired implant may be manufactured according to one embodiment of the present invention.

FIG. 8 is a flow diagram illustrating the direct design and production of a custom-fit prosthesis according to one embodiment of the present invention.

FIG. 9 illustrates a skull with a large bony defect in the right frontal-parietal area. This is a full-thickness defect resultant from previous surgery.

FIG. 10 illustrates a cranioplasty implant by itself

FIG. 11 illustrates a design of a cranioplasty implant in place on the skull meant re repair and reshape the missing bone.

FIG. 12 illustrates the implant embedded into one half of the block that will become the mold according to one embodiment of the present invention.

FIG. 13 illustrates the implant embedded into one half of the block that will become the mold and the other half of the mold moving into place according to on embodiment of the present invention.

FIG. 14 illustrates the finished mold with the implant subtracted from the two box halves. Bottom illustration shows the finished mold put together. Note two circular holes used for injection of the final implant material.

FIG. 15 illustrates the finished mold halves in an open position.

FIG. 16 illustrates a cross section through the mold showing the void inside for the implant and the circular injection holes.

FIG. 17 illustrates making the mold as a negative object.

FIG. 18 illustrates the “mold of a mold” concept showing the new mold used to form a positive of the actual mold.

FIG. 19 illustrates pouring in a mold material into the mold.

FIG. 20 illustrates the completion of the pouring of the new mold.

FIG. 21 illustrates the new mold produced in a new mold material.

### SUMMARY

Systems and methods for designing and producing custom-fit prosthesis are described. According to one embodiment, a mold is produced from which a custom-fit implant may be directly manufactured. Medical image data representing surrounding portions of a patient's anatomy to be repaired by surgical implantation of the custom-fit implant are received. Then, three-dimensional surface reconstruction is performed based on the medical image data. Next, the custom-fit implant is designed based on the three-dimensional surface reconstruction and a two-part mold is created with a void in the shape of the custom-fit implant by subtracting a representation of the custom-fit implant from a representation of a mold. Finally, the two-part mold is output from which the custom-fit implant may be directly manufactured.

Other features of embodiments of the present invention will be apparent from the accompanying drawings and from the detailed description that follows.

### DETAILED DESCRIPTION

Systems and method are described for designing and producing custom-fit prosthesis. Broadly stated, embodiments of the present invention make use of sophisticated software packages and rapid prototyping processes to facilitate the design and production of preformed implants. According to one embodiment, based upon computer-designed, preformed implants, precise molds are directly produced from which the desired implant may be manufactured. According to another embodiment, “a mold of a mold” may be produced from which a new mold may be formed and used to manufacture the desired implant. According to another embodiment, data files representing models of such implants or molds thereof may be delivered to implant manufacturers.

According to one embodiment, results of an outsourced medical modeling service may be provided via an Extranet, a secure portal, a Virtual Private Network (VPN), or other communication infrastructure designed to carry data between or among computers.

In the following description, for the purposes of explanation, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided in whole or in part as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to design and manufacture of custom-fit cranioplasty prostheses, embodiments of the present invention are equally applicable to other implant and prostheses design and manufacturing scenarios, including dental and other facial implants for reconstruction of the oral and/or maxillofacial region, orthopedic implants and the like.

Terminology

Brief definitions of terms used throughout this application are given below.

The terms “connected” or “coupled” and related terms are used in an operational sense and are not necessarily limited to a direct connection or coupling.

The term “implant” generally refers to a surgically implanted structure or device, such as a dental implant a subcutaneous implant, or a prosthesis. Examples of implants include cranioplasty prostheses, facial implants for reconstruction of the oral and/or maxillofacial region, orthopedic implants and the like.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

Overview

The method described herein, according to one embodiment of the present invention, allows the surgeon to go into surgery with a computer-designed, preformed implant that is perfectly fitting. The concept is that the patient is exposed to a computed tomography (CT) scan or some other medical imaging modality that allows for the visualization of a defect to be corrected. The 2D images obtained from the CT scan may then be used to visualize on the computer the defect in three dimensions. From this, an implant, e.g., a cranioplasty, is computer designed to recontour and repair the defect. In one embodiment, this cranioplasty is digitally reproduced and subtracted from another object, forming a core and cavity mold. The mold may then be output as a positive or a negative using Solid Freeform Fabrication (“SFF”) technology (see e.g., Wohlers Report 2002, published by Wohlers Associates, Inc., April 2002, 205 pages, softbound) for injection or forming of an implantable material. Alternatively, the delivery model may include providing data representative of the molds and/or the implant to an implant manufacturer for in-house production of the implant and/or mold by the implant manufacturer.

According to one embodiment, the following steps are part of the new method of design and production of custom-fit implants:
Step 1: The patient gets a CT scan in their local medical imaging facility. Medical image data (e.g., CT or MRI) in two-dimensional format is transferred to the laboratory that will be used in designing the implant. This data is typically stored in a medical imaging format that allows for visualization of the anatomy in cross sections, such as a format in accordance with the Digital Imaging and Communications in Medicine (DICOM) Standard defined by a joint committee of the American College of Radiology (ACR) and the National Electrical Manufacturers Association (NEMA).
Step 2: Three-dimensional surface reconstruction of the patient's defect is performed in the computer. Where the implant being designed is a cranioplasty, this three-dimensional representation of the patient's skull anatomy is output in stereolithography (STL) file format. The dura mater (brain covering) can also be visualized and output at this stage if needed as part of the implant design process.
Step 3: The STL file(s) are imported into a design software for design of the cranioplasty implant. The design of the implant is based on the patient's own surrounding anatomy, contralateral (the other side) anatomy, and if needed, other normative skull anatomy. Design of the implant is done taking into account the thickness of the surrounding skull to allow for an implant that approximates the individual patient's normal anatomy. The imaged dura mater from the CT scan can also be used as an inner table for the implant. One element of this method is that the implant may be completely designed in the computer.
Step 4: Once the design of the implant is complete, a “box” is created in the computer. The computer model of the implant is embedded into one side of the box model. the implant is then subtracted from the box, creating a void in the shape of the implant on one side of the box. The box file is smoothed, creating a “parting line” for the eventual mold. A second box is created in the computer and positioned over the top of the first. The implant and the first box are then subtracted from the second box, thus creating a box with a void on one side for the implant and a fit to the first box. When the implant file is now taken away, the box is now a two-part mold with the shape of the implant inside of it. Further circular files can be subtracted from the mold halves to allow for the creation of holes for material injection nozzles, etc. Another element of this method is that the mold may be completely designed in the computer needing no manual adjustment.
Step 5: Once the mold is completely designed in the computer it is then output using a SFF process either as a positive model or as a negative model. A positive model can be output for direct injection of the implantable material. Alternatively, a negative model of the mold can be output to allow for forming of the mold in another material (e.g., silicone, urethane, rubber, etc). Current SFF techniques include stereolithography, selective laser sintering, fused deposition modeling, multi-jet modeling and 3D printing. The SFF processes produce a three-dimensional object in a series of two-dimensional layers. The two-dimensional layers are built one on top of another until the object is created. If creating a positive of the mold, the material used will be durable enough to allow for injection of the implant material and could be composed of plaster, epoxy resin, acrylic resin, urethane, ABS, stainless steel, a mixture of any of these, or other materials. If creating a negative of the mold the material used will be durable enough to allow for forming of the mold material.
Step 6: Once the mold is produced, the implant material is then formed within the mold. For liquid-type implant materials, an injector will be used. For bead-type implant materials, a slurry is created and a large amount of the material is “sandwiched” between both sides of the mold while the are compressed. The implant material can be any implantable material, including, but not limited to, polymethylmethacrylate, bead polymethylmethacrylate, polyethylene, bead polyehtylene, cobalt-chrome, titanium, hydroxyapatite, and polytetrafluoroethylene. The implant material is allowed to harden and then is removed from the mold. Minor finishing to the cranioplasty implant is done to remove any flash or extra material produced during the injection or forming process.

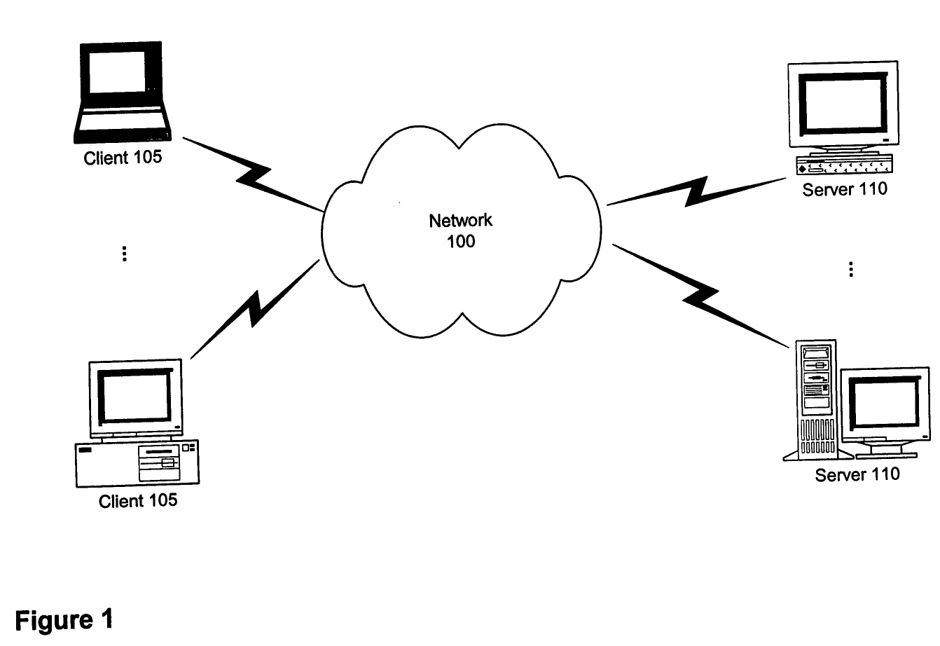

FIG. 1 conceptually illustrates a high-level, simplified view of a network environment in which one embodiment of the present invention may be employed. In the exemplary client-server environment depicted, such as the World Wide Web (the Web), efficient business-to-consumer or business-to-business communication and commerce may take place. The architecture of the Web follows a conventional client-server model. The terms “client” and “server” are used to refer to a computer's general role as a requester of data (the client) or provider of data (the server). Web clients 105 and Web servers 110 communicate using a protocol such as HyperText Transfer Protocol (HTTP). In the Web environment, Web browsers reside on clients and render Web documents (pages) served by the Web servers. The client-server model is used to communicate information between clients 105 and servers 110. Web servers 110 are coupled to a communications network, such as the Internet 100, and respond to document requests and/or other queries from Web clients 105. When a user selects a document by submitting its Uniform Resource Locator (URL), a Web browser, such as Netscape Navigator or Internet Explorer, opens a connection to a server 110 and initiates a request (e.g., an HTTP get) for the document. The server 110 delivers the requested document, typically in the form of a text document coded in a standard markup language such as HyperText Markup Language (HTML).

According to one embodiment, client 105 and server 110 systems may include various parties involved in the capture of medical imaging data, prosthesis design, prosthesis development, prosthesis manufacturing, and/or prosthesis implantation process, such as medical imaging services/sources, custom prosthesis developers, implant manufacturers, surgeons, model makers, and others.

In one embodiment, medical imaging data may be provided from a remote medical imaging system to a custom prosthesis developer. Subsequently, refinement, verification and/or delivery of data files representative of models of a target prosthesis, the surrounding bone structure, molds of the target prosthesis, or the like may be performed by secure online interactions among the relevant parties computer systems and databases. For example, clients 105 and servers 110 may communicate by way of a dial up connection, digital subscriber line (DSL) service, cable modem, integrated services digital network (ISDN) service, wireless service provider (WSP) or other internet service provider (ISP), for example.

According to one embodiment, the network 100 is a private communications network, such as a LAN (e.g., an Ethernet LAN or a token ring LAN), an Intranet, an Extranet, a VPN, or any other communication structure designed to carry data between a plurality of computers associated with a particular enterprise or organization. The network 100 may consist of many inter-linked LANs and/or leased lines in a wide area network (WAN) or the Internet. According to another embodiment, the network 100 is a public communications network, such as a WAN, an Extranet or the Internet. Additionally, according to one embodiment, the communication links among the clients 105, servers 110, and network 100 may be secured or encrypted using conventional web protocols, such as Secure HTTP (S-HTTP), Secure Sockets Layer (SSL), or the like.

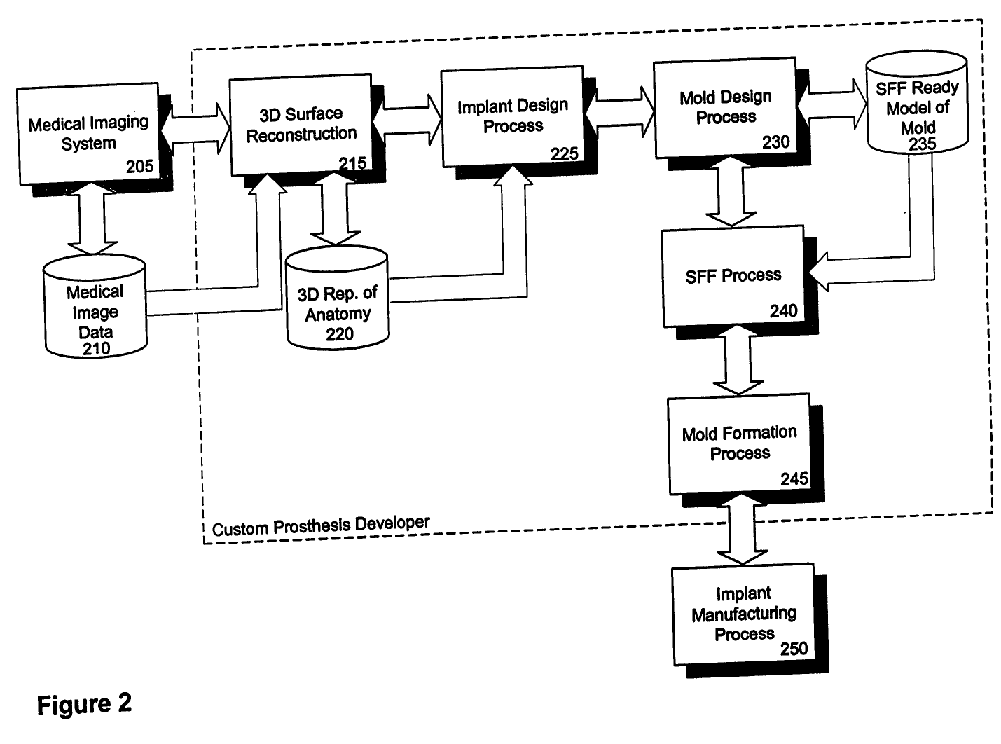

FIG. 2 is a block diagram that conceptually illustrates a custom prosthesis development system according to a first embodiment of the present invention in which the final mold from which the implant may be directly manufactured or data files representative thereof may be delivered to an implant manufacturer.

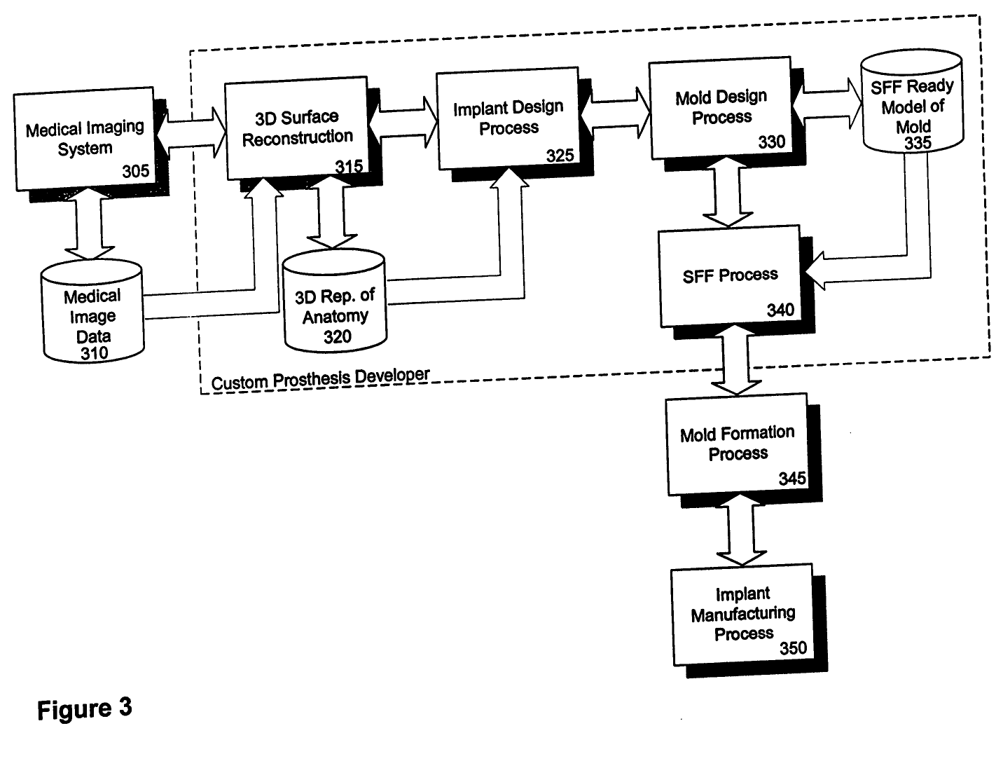

FIG. 3 is a block diagram that conceptually illustrates a custom prosthesis development system according to a second embodiment of the present invention in which “a mold of a mold” from which the final mold may be manufactured or data files representative thereof may be delivered to an implant manufacturer.

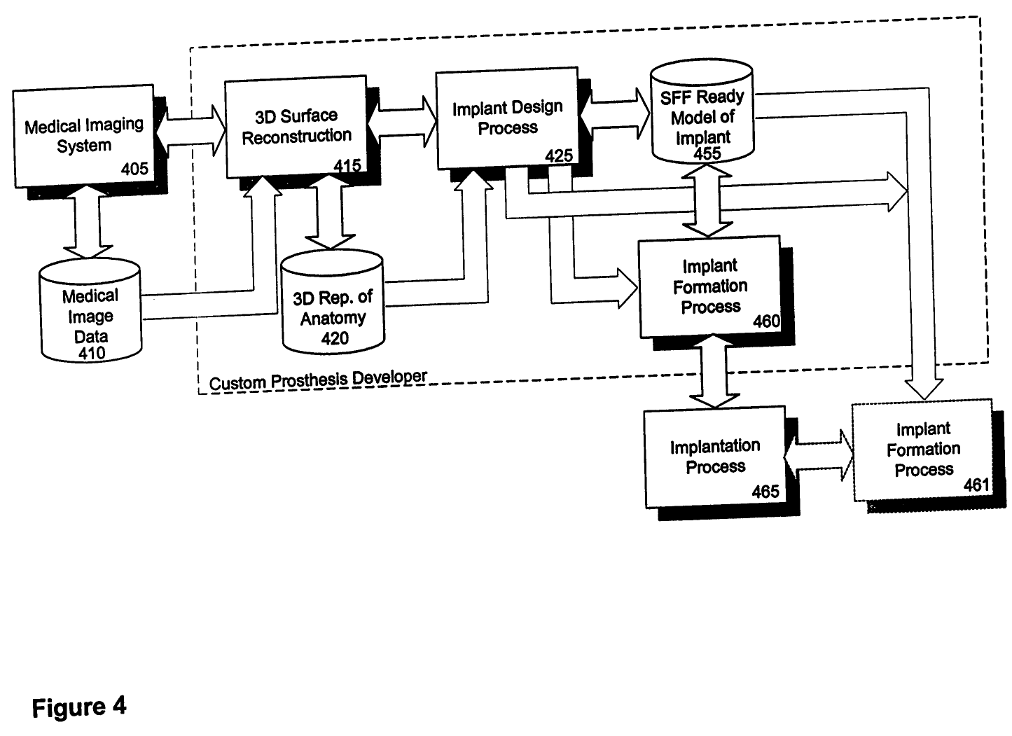

FIG. 4 is a block diagram that conceptually illustrates a custom prosthesis development system according to a third embodiment of the present invention in which the implant or data files representative thereof may be delivered.

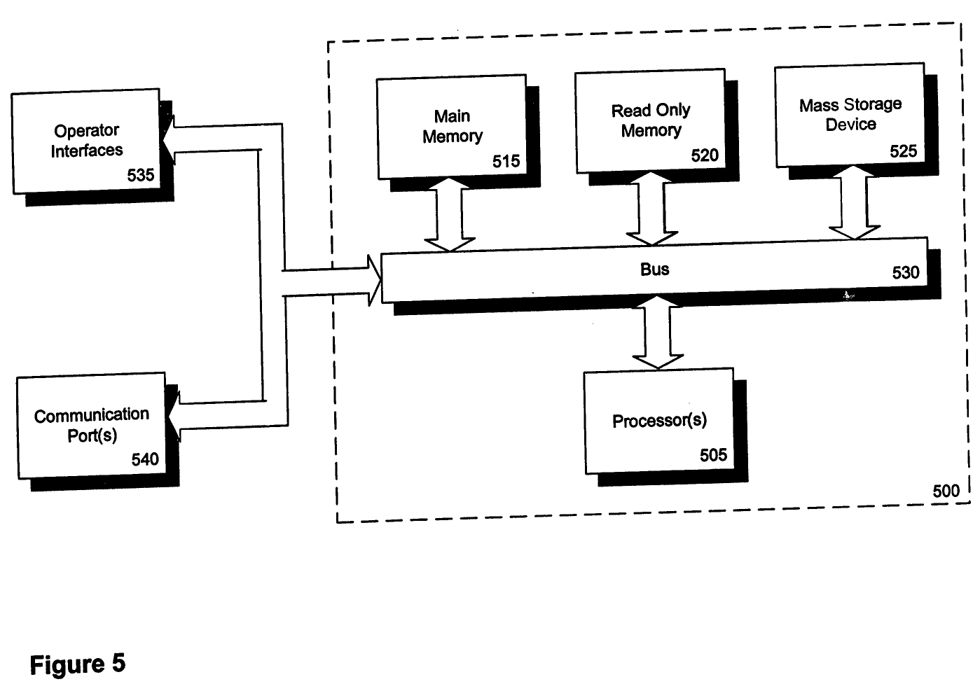

An exemplary computer system 500, representing an exemplary application server, web server, or database server, in which features of the present invention may be implemented will now be described with reference to FIG. 5. In this simplified example, the computer system 500 comprises a bus 530 or other communication means for communicating data and control information, and one or more processors 505, such as SPARC® processors, PowerPC G4 processors, Intel® Pentium®, Itanium® or Itanium 2 processors or the like, coupled with bus 530.

Computer system 500 further comprises a random access memory (RAM) or other dynamic storage device (referred to as main memory 515), coupled to bus 530 for storing information and instructions to be executed by processor(s) 505. Main memory 515 also may be used for storing temporary variables or other intermediate information during execution of instructions by processor(s) 515.

Computer system 500 also comprises a read only memory (ROM) 520 and/or other static storage device coupled to bus 530 for storing static information and/or instructions for processor(s) 505.

A mass storage device 525, such as a magnetic disk or optical disc and its corresponding drive, may also be coupled to bus 530 for storing information and instructions, such as an operating system, a web server, a relational database management system (RDBMS), initialization files, etc.

Computer system 500 may also include a operator interfaces, such as a display, keyboard, and other user input devices (not shown) for allowing an operator to interact with the computer system 500 and/or provide maintenance, monitoring, or support services.

One or more communication ports 540 may also be coupled to bus 530 for supporting network connections and communication of information to/from the computer system 500 by way of a LAN, WAN, the Internet, or the public switched telephone network (PSTN), for example. The communication ports 540 may include various combinations of well-known interfaces, such as one or more modems to provide dial up capability, one or more 10/100 Ethernet ports, one or more Gigabit Ethernet ports (fiber and/or copper), or other well-known network interfaces commonly used in internetwork environments. In any event, in this manner, the computer system 500 may be coupled to a number of other network devices, clients and/or servers via a conventional network infrastructure, such as an enterprise's Intranet and/or the Internet, for example.

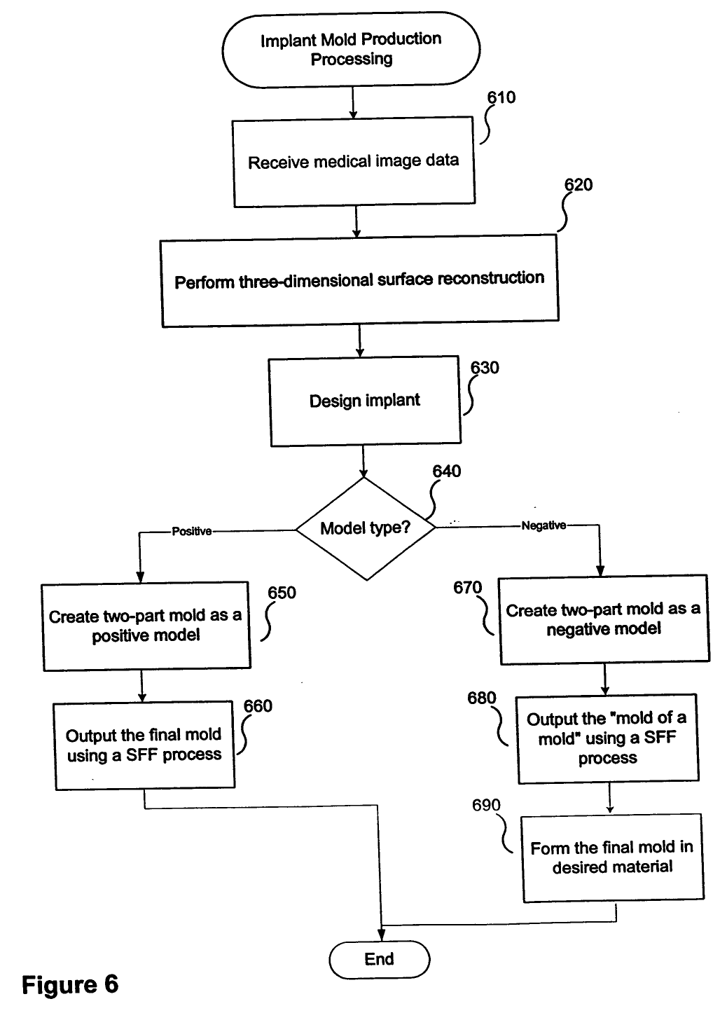

FIG. 6 is a flow diagram illustrating the design and production of a final mold from which a custom-fit prosthesis may be directly manufactured according to one embodiment of the present invention.

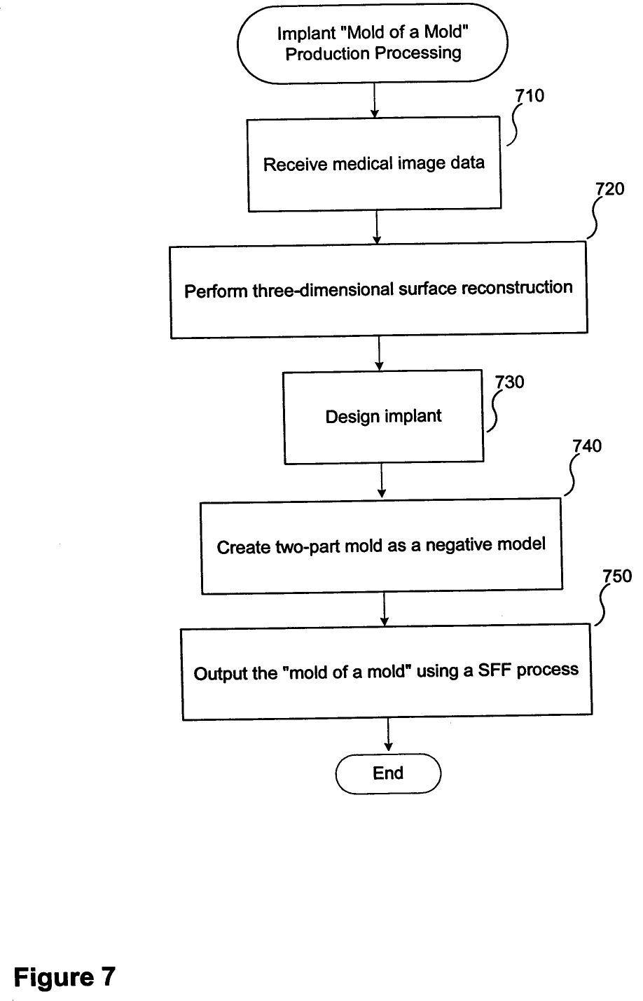

FIG. 7 is a flow diagram illustrating the design and production of “a mold of a mold” from which a final mold for the desired implant may be manufactured according to one embodiment of the present invention.

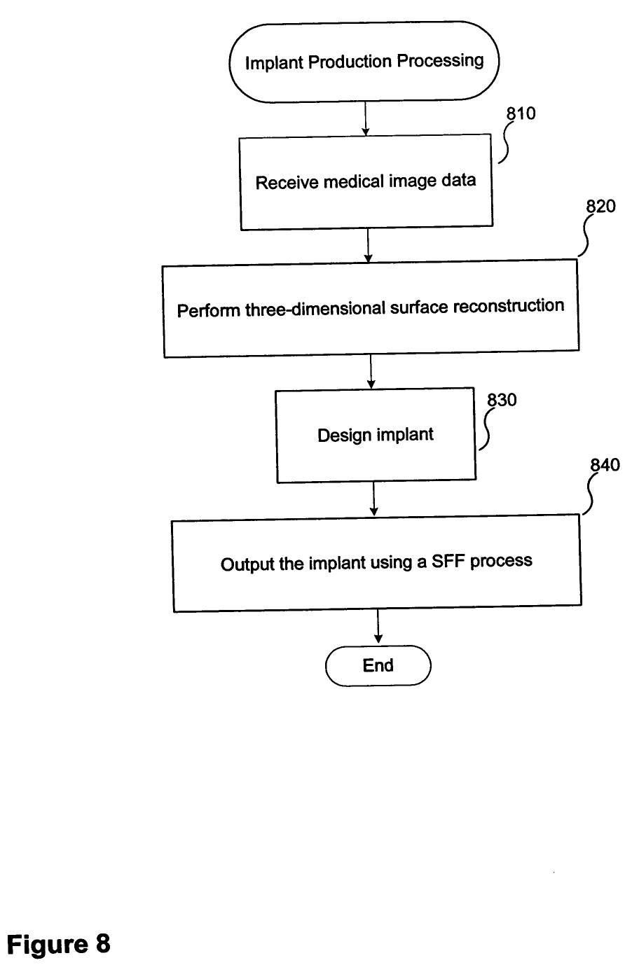

FIG. 8 is a flow diagram illustrating the direct design and production of a custom-fit prosthesis according to one embodiment of the present invention.

FIG. 9 illustrates a skull with a large bony defect in the right frontal-parietal area. This is a full-thickness defect resultant from previous surgery.

FIG. 10 illustrates a cranioplasty implant by itself.

FIG. 11 illustrates a design of a cranioplasty implant in place on the skull meant re repair and reshape the missing bone.

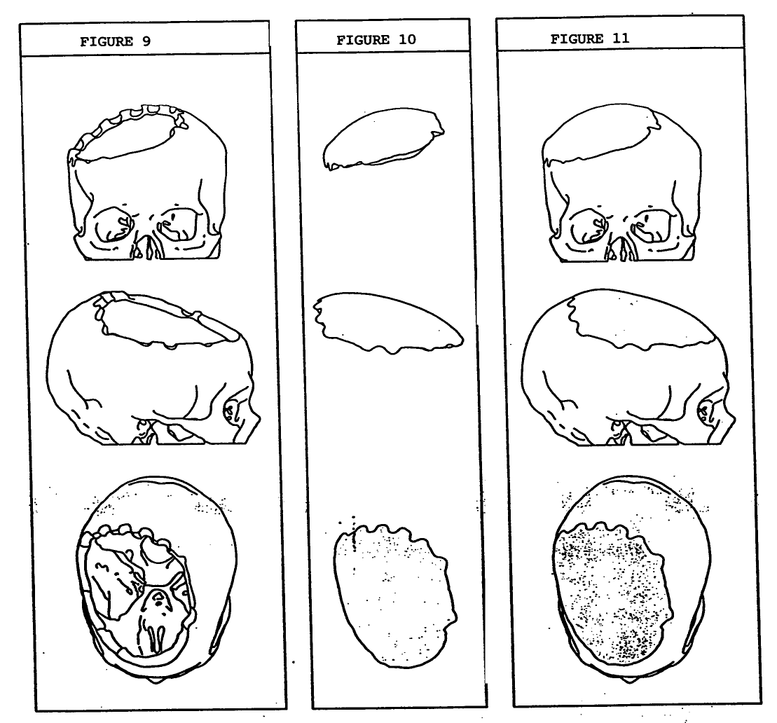

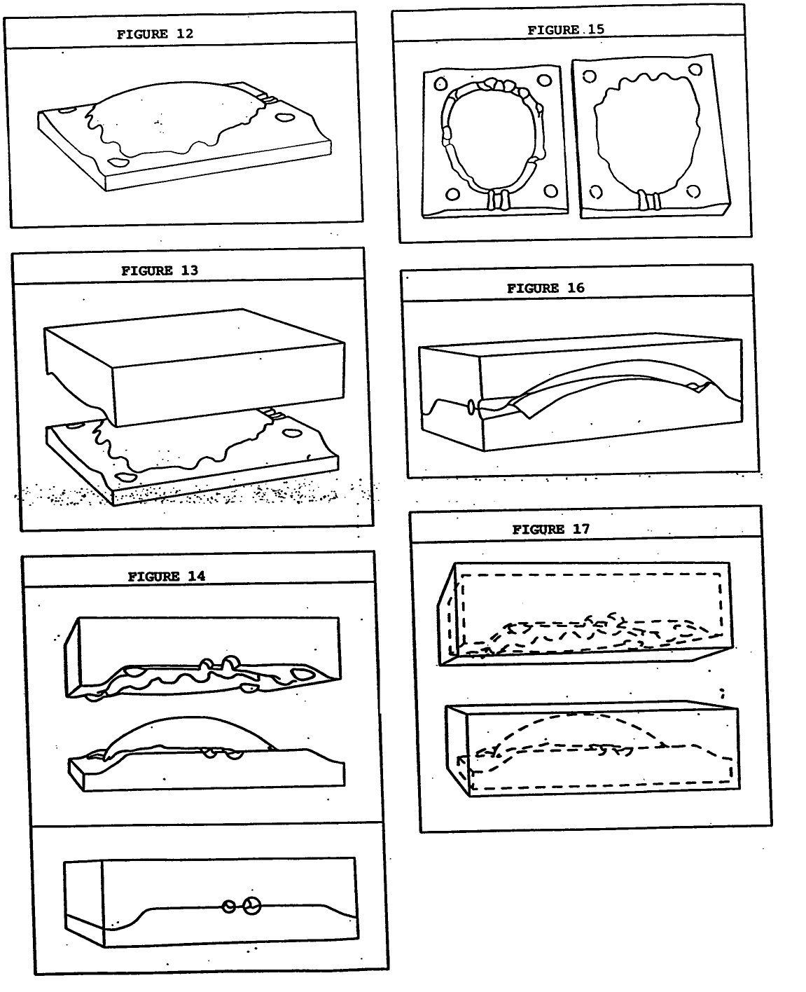

FIG. 12 illustrates the implant embedded into one half of the block that will become the mold according to one embodiment of the present invention.

FIG. 13 illustrates the implant embedded into one half of the block that will become the mold and the other half of the mold moving into place according to on embodiment of the present invention.

FIG. 14 illustrates the finished mold with the implant subtracted from the two box halves. Bottom illustration shows the finished mold put together. Note two circular holes used for injection of the final implant material.

FIG. 15 illustrates the finished mold halves in an open position.

FIG. 16 illustrates a cross section through the mold showing the void inside for the implant and the circular injection holes.

FIG. 17 illustrates making the mold as a negative object.

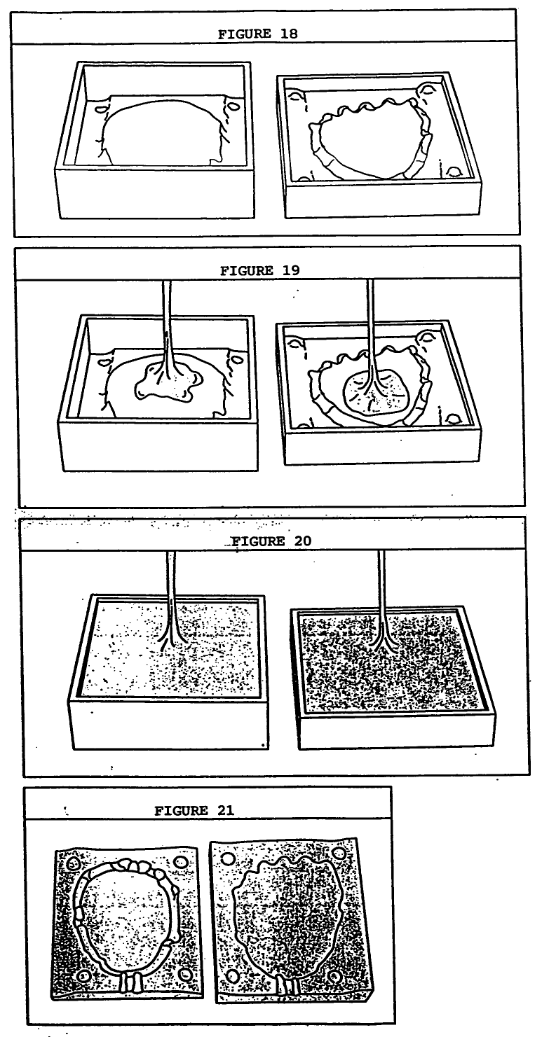

FIG. 18 illustrates the “mold of a mold” concept showing the new mold used to form a positive of the actual mold.

FIG. 19 illustrates pouring in a mold material into the mold.

FIG. 20 illustrates the completion of the pouring of the new mold.

FIG. 21 illustrates the new mold produced in a new mold material.

Further details regarding the steps in the described new method of design and production of these implants, according to one embodiment of the present invention, are provided in the above-referenced provisional patent applications which have been incorporated by reference herein.

In the foregoing specification and in the provisional patent applications incorporated herein, the invention is described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method a producing a mold from which a custom-fit implant may be directly manufactured, the method comprising:
receiving medical image data representing surrounding portions of a patient's anatomy to be repaired by surgical implantation of the custom-fit implant;
performing three-dimensional surface reconstruction based on the medical image data;
designing the custom-fit implant based on the three-dimensional surface reconstruction;
creating a two-part mold with a void in the shape of the custom-fit implant by subtracting a representation of the custom-fit implant from a representation of a mold; and
outputting the two-part mold from which the custom-fit implant may be directly manufactured.
